(19) United States
(12) Patent Application Publication
(10) Pub. No.: US 2026/0159019 A1
(43) Pub. Date: Jun. 11, 2026

(54) PASSENGER SEAT AIRBAG DEVICE

(71) Applicant: TOYODA GOSEI CO., LTD., Kiyosu-shi (JP)

(72) Inventor: Shota WATANABE, Aichi (JP)

(21) Appl. No.: 19/408,055

(22) Filed: Dec. 3, 2025

(30) Foreign Application Priority Data
Dec. 6, 2024 (JP) 2024-213980

(51) Int. Cl. B60R 21/233; B60R 21/205; B60R 21/237

(52) U.S. Cl. CPC B60R 21/233; B60R 21/205; B60R 21/237

(57) ABSTRACT

A passenger seat airbag device has an airbag, an inflator, and a control mechanism. The airbag includes a main bag portion, a subsidiary bag portion which communicates with the main bag portion and is inflated to protrude rearward from a side of an occupant-side wall portion of main bag portion, and a coupling member which has a base end portion coupled to an inner peripheral surface of the subsidiary bag portion and a distal end portion coupled to the control mechanism. The subsidiary bag portion is in a state of being drawn into the main bag portion through the communication portion when the main bag portion is inflated in a state where coupling between the coupling member and the control mechanism is maintained. The subsidiary bag portion is inflated to protrude rearward when the main bag portion is inflated in a state where the coupling is released.

### CROSS-REFERENCE TO RELATED APPLICATIONS

This application is based on and claims priority under 35 USC 119 from Japanese Patent Application No. 2024-213980 filed on Dec. 6, 2024, the entire content of which is incorporated herein by reference.

### TECHNICAL FIELD

The present disclosure relates to a passenger seat airbag device that is disposed in front of an occupant seated in a passenger seat and is configured to control an inflation shape of an airbag by a control mechanism.

### BACKGROUND ART

In the related art, in a passenger seat airbag device that controls inflation of an airbag by a control mechanism, the airbag includes a main bag portion, and a subsidiary bag portion whose inflation is controlled by the control mechanism. In the passenger seat airbag device of the related art, the subsidiary bag portion is disposed so as to cover a rear surface side of the main bag portion such that an upper end side and a lower end side are temporarily joined to a main bag portion side by temporary sewn portions, and the main bag portion and the subsidiary bag portion communicate with each other via a valve mechanism coupled to the control mechanism by a coupling member. When the coupling between the coupling member and the control device is released, an inflation gas flows into the subsidiary bag portion via the opened valve mechanism, and the subsidiary bag portion is inflated together with the main bag portion so as to release the temporary joining by the temporary sewn portions on both the upper and lower end sides, and in a state where the coupling between the coupling member and the control device is maintained, the valve mechanism is not opened, and only the main bag portion is inflated (for example, see CN220594851U).

However, in the passenger seat airbag device of the related art, the subsidiary bag portion is configured to be inflated while releasing the temporarily joined state to the main bag portion by the temporary sewn portions on both the upper and lower end sides when the inflation gas is caused to flow into the subsidiary bag portion via the valve mechanism to inflate, and thus it is difficult to make a timing to release the temporary joining (breaking timing to break sewing thread) constant, in other words, there is variation in an inflation timing of the subsidiary bag portion, and there is room for improvement in stably protecting the occupant by the airbag fully inflated.

### SUMMARY OF INVENTION

An object of the present disclosure is to provide a passenger seat airbag device capable of stably protecting an occupant by an airbag fully inflated even when the airbag device is configured to have different inflation modes.

An aspect of the present disclosure relates to a passenger seat airbag device, having:
an airbag that is disposed in front of an occupant seated in a passenger seat and is folded and stored in a storage portion;
an inflator that supplies an inflation gas to the airbag; and
a control mechanism that controls an inflation shape of the airbag, in which
the airbag is formed in a bag shape having flexibility, and includes:
   a main bag portion provided with an inflow opening for allowing the inflation gas to flow into an inside of the airbag, and configured to have an occupant-side wall portion disposed to face the occupant on a rear end side at a time of full inflation, in which a peripheral edge of the inflow opening on a front end side at the time of full inflation is coupled to a side of the storage portion; and
   a subsidiary bag portion configured to communicate with the main bag portion and to be inflated to protrude rearward from a side of the occupant-side wall portion, in which inflation of the subsidiary bag portion is controlled by the control mechanism,
the airbag further includes a coupling member disposed in the main bag portion, the coupling member having a base end portion which is coupled to an inner peripheral surface of the subsidiary bag portion and a distal end portion which is coupled to the control mechanism disposed in a vicinity of the inflow opening, and
the subsidiary bag portion communicates with the main bag portion via a communication portion, and is configured,
   when the main bag portion is inflated in a state where coupling between the coupling member and the control mechanism is maintained, to be in a state of being drawn into the main bag portion through the communication portion, and
   when the main bag portion is inflated in a state where the coupling between the coupling member and the control mechanism is released, to be inflated to protrude rearward from the occupant-side wall portion such that the occupant is protected by a rear surface of the subsidiary bag portion at a time of full inflation.

In the passenger seat airbag device of the aspect, the airbag includes the main bag portion, and the subsidiary bag portion whose inflation is controlled by the control mechanism. The subsidiary bag portion whose inflation is controlled by the control mechanism is configured to be coupled to the control mechanism by a coupling member, and is configured to be in a non-inflated state where the subsidiary bag portion is drawn into the main bag portion through a communication portion when coupling between the coupling member and the control mechanism is maintained, and to be inflated so as to protrude rearward from an occupant-side wall portion disposed on a rear end side of the main bag portion by causing an inflation gas to flow into the inside through the main bag portion and the communication portion when the coupling between the coupling member and the control mechanism is released. That is, in the passenger seat airbag device of the aspect, since the inflation of the subsidiary bag portion is controlled only by maintaining or releasing a coupled state between the control mechanism and the coupling member extending from the subsidiary bag portion, it is possible to prevent variation in an inflation timing of the subsidiary bag portion even in a case where the subsidiary bag portion is inflated in addition to the main bag portion. Further, in the passenger seat airbag device of the aspect, in a case where the airbag is fully inflated in a state where the coupling between the coupling member and the control mechanism is maintained, the subsidiary bag portion is not exposed to the outside in a state of being drawn into the main bag portion, and the occupant can be properly received by the occupant-side wall portion of the main bag portion fully inflated, and in a case where the airbag is fully inflated in a state where the coupling between the coupling member and the control mechanism is released, a rear surface of the subsidiary bag portion inflated so as to protrude rearward from the main bag portion can properly receive the occupant.

Therefore, in the passenger seat airbag device of the aspect, even when the airbag device is configured to have different inflation modes, the occupant can be stably protected by the airbag fully inflated.

In the passenger seat airbag device of the aspect, the airbag is formed in a bag shape by joining peripheral edges of base materials having a predetermined shape formed of a sheet body having flexibility to each other,
the subsidiary bag portion includes a front-side wall portion and a rear-side wall portion having a substantially same outer shape, the front-side wall portion being disposed on
a front surface side facing the occupant-side wall portion at the time of full inflation, and the rear-side wall portion being disposed on a rear surface side to face the front-side wall portion,
the occupant-side wall portion includes two occupant-side panel portions dividing the occupant-side wall portion into two in an up-down direction or a left-right direction,
each of the occupant-side panel portions is configured such that a front wall forming portion constituting a half region of the front-side wall portion in the subsidiary bag portion is disposed to protrude on an inner edge side in which inner edges constitute a central region of the occupant-side wall portion and are joined to each other,
a rear panel portion constituting the rear-side wall portion in the subsidiary bag portion has an outer shape which is substantially equal to a shape of a state where each front wall forming portion of each of the occupant-side panel portions is opened in a state where the inner edges are joined to each other, and
the coupling member is formed to extend from two positions facing each other in a direction along a dividing direction of the occupant-side wall portion on an outer peripheral edge of the subsidiary bag portion.

With such a configuration of the passenger seat airbag device, the subsidiary bag portion can be formed by joining a remaining edge portion of a front wall forming portion and an outer peripheral edge of a rear panel portion in each occupant-side panel portion in a state where inner edges are joined to each other. That is, in the airbag in the passenger seat airbag device having the above configuration, the occupant-side wall portion of the main bag portion and the subsidiary bag portion can be formed by a planar joining work, and thus the airbag can be easily manufactured. In addition, in the passenger seat airbag device having the above configuration, the subsidiary bag portion is configured by joining outer peripheral edges of a front-side wall portion and a rear-side wall portion having substantially the same outer shape to each other, and the coupling member is formed so as to extend from an inner peripheral surface side of two positions (that is, positions substantially at centers of edge portions of respective front wall forming portions) facing each other in a direction along a dividing direction of the occupant-side wall portion on the outer peripheral edge of the subsidiary bag portion. Therefore, when the main bag portion is inflated in a state where the coupling between the coupling member and the control mechanism is maintained, the subsidiary bag portion is disposed in the main bag portion so as to be pulled by the coupling member and folded in half while being entirely inverted. In other words, in a state where the coupling between the coupling member and the control mechanism is maintained, the subsidiary bag portion is not bulky in the main bag portion, and is disposed so as to be recessed forward in a pocket shape from the occupant-side wall portion such that a slit-shaped opening formed by a region around the communication portion is disposed in the occupant-side wall portion, and thus it is possible to stably inflated only the main bag portion without affecting the inflation shape of the main bag portion.

Further, in the passenger seat airbag device having the above configuration, when the occupant-side panel portions are configured to divide the occupant-side wall portion into two in the left-right direction, the subsidiary bag portion disposed in a pocket shape so as to be recessed forward from the occupant-side wall portion is disposed such that the slit-shaped opening on the rear end side is substantially along an up-down direction in the occupant-side wall portion at the time of full inflation of the main bag portion in a state where the coupling between the coupling member and the control mechanism is maintained. Therefore, in a case where only the main bag portion is inflated, it is possible to protect a head portion of the occupant by allowing the head portion to enter the pocket-shaped region (slit-shaped opening formed in occupant-side wall portion along up-down direction). In addition, in the airbag having such a configuration, by changing a position of the front wall forming portion in the up-down direction with respect to the occupant-side panel portion, a position of the subsidiary bag portion in the up-down direction with respect to the main bag portion (occupant-side wall portion) can be easily adjusted as necessary.

In the passenger seat airbag device having the above configuration, the airbag is stored in the storage portion in a state of a folded-up body in which a preliminary folded bag formed by deploying the occupant-side wall portion in the main bag portion substantially flat and disposing the occupant-side wall portion on the inflow opening is folded to be reduced in front-rear and left-right directions, and
in the preliminary folded bag, the subsidiary bag portion is disposed on the occupant-side wall portion of the main bag portion in a state of being deployed flat such that the front-side wall portion and the rear-side wall portion overlap each other.

In the passenger seat airbag device having such a configuration, the airbag is folded in a state where the subsidiary bag portion is exposed to the outside of the main bag portion, and is stored in a storage portion. Therefore, when the airbag is inflated in a state where the coupling between the coupling member and the control mechanism is released, the subsidiary bag portion is inflated by causing the inflation gas to flow into the subsidiary bag portion from a state where the subsidiary bag portion is exposed on the rear surface side of the main bag portion, and thus the subsidiary bag portion can be inflated quickly and smoothly.

### BRIEF DESCRIPTION OF DRAWINGS

Exemplary embodiment(s) of the present invention will be described in detail based on the following figures, wherein:

FIG. 1 is a schematic view illustrating the vicinity where a passenger seat airbag device according to an embodiment of the present disclosure is mounted;

FIG. 2 is a schematic enlarged longitudinal sectional view of the airbag device according to the embodiment in a front-rear direction;

FIG. 3 is a schematic enlarged longitudinal sectional view of the airbag device according to the embodiment in a left-right direction;

FIG. 4 is a perspective view of a state where an airbag used in the airbag device according to the embodiment is inflated alone, illustrating a state where both a subsidiary bag portion and a gas exhaust portion are drawn;

FIG. 5 is a schematic longitudinal sectional view of the airbag in FIG. 4 taken along the front-rear direction;

FIG. 6 is a schematic cross-sectional view of the airbag in FIG. 4 taken along the front-rear direction;

FIG. 7 is a schematic longitudinal sectional view taken along the front-rear direction illustrating the vicinity of the subsidiary bag portion in a state where the subsidiary bag portion is inflated in the airbag according to the embodiment;

FIG. 8 is a schematic cross-sectional view taken along the front-rear direction illustrating the vicinity of the subsidiary bag portion in a state where the subsidiary bag portion is inflated in the airbag according to the embodiment;

FIG. 9 is a plan view illustrating base materials constituting the airbag according to the embodiment;

FIG. 10 is a plan view illustrating remaining base materials constituting the airbag according to the embodiment;

FIG. 11 is a plan view and a bottom view illustrating a state where the airbag according to the embodiment is preliminarily folded;

FIG. 12 is a schematic longitudinal sectional view taken along the front-rear direction illustrating a state where the airbag is fully inflated in a small-volume mode in the airbag device according to the embodiment;

FIG. 13 is a schematic longitudinal sectional view taken along the front-rear direction illustrating a state where the airbag is fully inflated in a large-volume mode in the airbag device according to the embodiment;

FIG. 14 is a schematic cross-sectional view taken along the front-rear direction illustrating a state where the airbag is fully inflated in the small-volume mode in the airbag device according to the embodiment;

FIG. 15 is a schematic cross-sectional view taken along the front-rear direction illustrating a state where the airbag is fully inflated in the large-volume mode in the airbag device according to the embodiment;

FIG. 16 is a schematic side viesw of the airbag device according to the embodiment at the time of full inflation of the airbag, illustrating the state in the small-volume mode and the state in the large-volume mode;

FIG. 17 is a schematic rear view illustrating a state where the airbag is fully inflated in the small-volume mode in the airbag device according to the embodiment, as viewed from a rear side of a vehicle;

FIG. 18 is a schematic view illustrating a state where a head portion of an occupant is received by the airbag inflated in the small-volume mode;

FIG. 19 is a schematic perspective view illustrating a state where an airbag according to another embodiment of the present disclosure is inflated alone in the small-volume mode; and

FIG. 20 is a plan view illustrating base materials constituting the airbag in FIG. 19.

### DESCRIPTION OF EMBODIMENTS

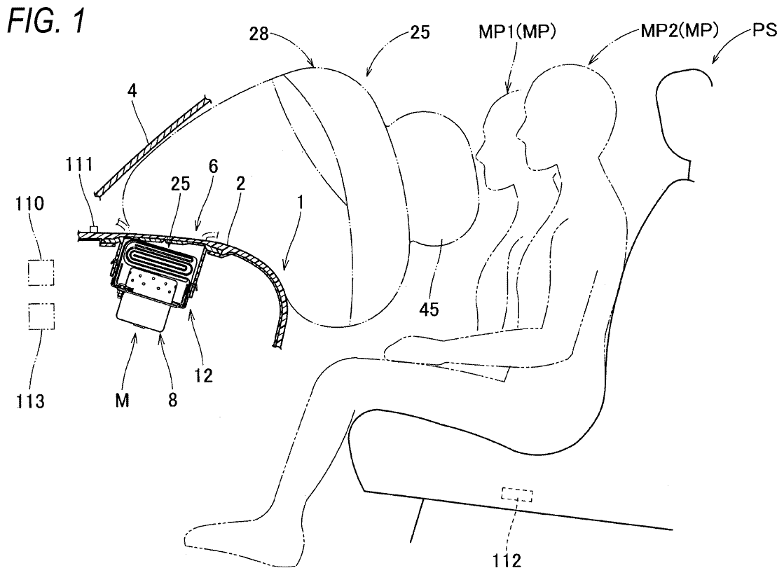

Hereinafter, one embodiment of the present disclosure will be described with reference to the drawings. As illustrated in FIG. 1, a passenger seat airbag device M (hereinafter, abbreviated as “airbag device”) according to the embodiment is a top mount type disposed inside an upper surface 2 of an instrument panel (hereafter, referred to as “in-panel”) 1 in front of a passenger seat PS in a vehicle. In the embodiment, a front-rear direction, an up-down direction, and a left-right direction coincide with a front-rear direction, an up-down direction, and a left-right direction of the vehicle unless otherwise specified.

As illustrated in FIGS. 1 to 3, the airbag device M includes a folded airbag 25, an inflator 8 that supplies an inflation gas to the airbag 25, a case 12 serving as a storage portion that stores and holds the airbag 25 and the inflator 8, a retainer 9 for attaching the airbag 25 and the inflator 8 to the case 12, an airbag cover 6 that covers the folded airbag 25, and two locking members 16L, 16R serving as a control mechanism that controls an inflation mode of the airbag 25. In the case of the embodiment, operations of the inflator 8 and the locking members 16L, 16R are controlled by a control device 110 illustrated in FIG. 1.

As illustrated in FIG. 1, the control device 110 inputs electric signals from a position detection sensor 111 capable of detecting a physique of an occupant MP seated in the passenger seat PS and a separation distance between the in-panel 1 and the occupant MP (position of passenger seat PS with respect to in-panel 1), a weight detection sensor 112 capable of detecting a weight of the occupant MP, a collision detection sensor 113 capable of detecting an acceleration and an acceleration direction of the vehicle, and the like, causes the inflator 8 to operate, and controls operations of the locking members 16L, 16R so as to inflate the airbag 25 in a suitable inflation mode.

The airbag cover 6 is formed integrally with the in-panel 1 made of a synthetic resin, and is configured such that two door portions of front and rear door portions 6a, 6b are pushed open by the airbag 25 when the airbag 25 is deployed and inflated. In addition, a coupling wall portion 6c that is coupled to the case 12 is formed around the door portions 6a, 6b of the airbag cover 6.

As illustrated in FIGS. 1 to 3, the inflator 8 includes a substantially cylindrical main body portion 8a having a plurality of gas discharge ports 8b, and a flange portion 8c for attaching the inflator 8 to the case 12.

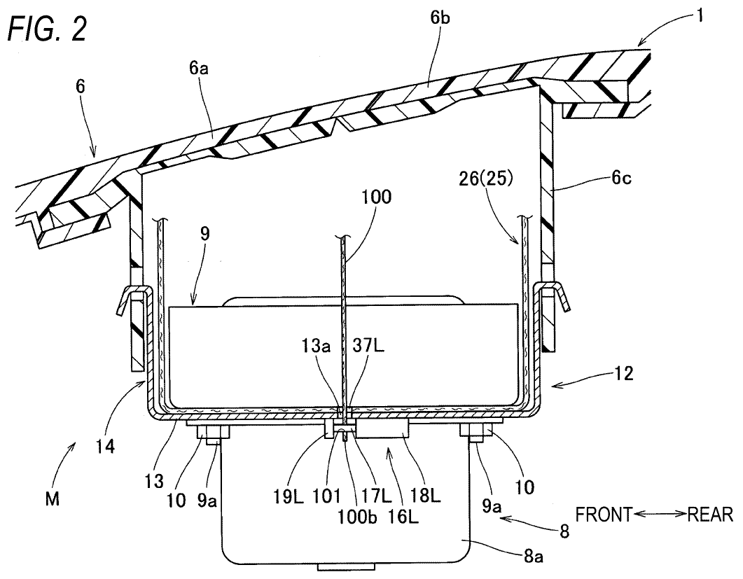

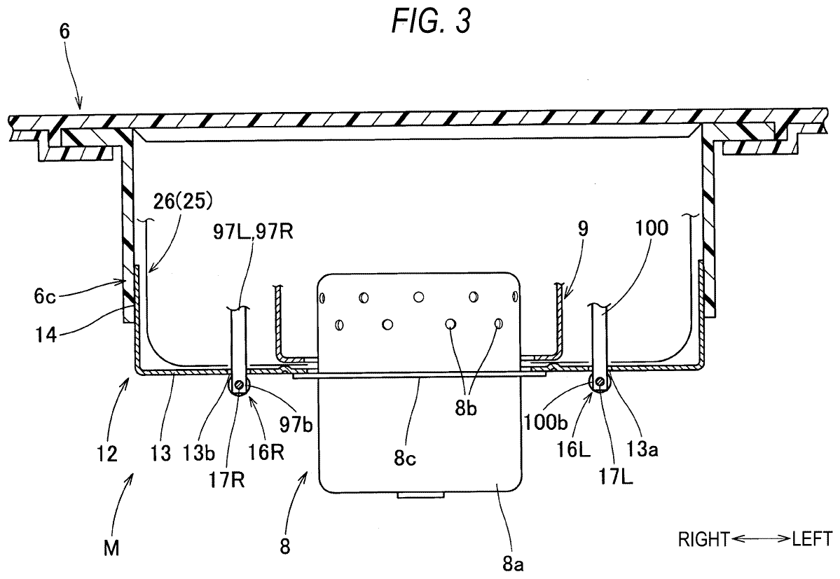

The case 12 serving as the storage portion is formed in a substantially rectangular parallelepiped shape made of sheet metal with a rectangular opening at an upper end side, and as illustrated in FIGS. 1 to 3, is provided with a substantially rectangular bottom wall portion 13 into which the inflator 8 is inserted and attached from below, and a peripheral wall portion 14 that extends upward from an outer peripheral edge of the bottom wall portion 13 and locks the coupling wall portion 6c of the airbag cover 6. In the case of the embodiment, the airbag 25 and the inflator 8 are coupled to the bottom wall portion 13 of the case 12 by passing through a peripheral edge of an inflow opening 35 in the airbag 25, the bottom wall portion 13 of the case 12, and the flange portion 8c of the inflator 8 using respective bolts 9a of the retainer 9 disposed in the airbag 25 as an attachment unit and fixing by nuts 10. The bottom wall portion 13 of the case 12 is formed to have a wide width in a left-right direction, and an insertion hole (reference numeral omitted) through which the main body portion 8a of the inflator 8 can be inserted and insertion holes (not illustrated) for allowing the respective bolts 9a of the retainer 9 to be inserted are arranged at a position at substantially the center in the left-right direction. In the bottom wall portion 13, through holes 13a, 13b are formed on both left and right sides of the insertion hole for allowing the main body portion 8a of the inflator 8 to be inserted (see FIGS. 2 and 3). The through hole 13a arranged on the left side is a through hole for allowing a distal end portion 100b of a coupling member 100 extending from a later-described gas exhaust portion 50 in the airbag 25 to be inserted. The through hole 13b arranged on the right side is a through hole for allowing a distal end portion 97b of coupling members 97L, 97R extending from a later-described subsidiary bag portion 45 in the airbag 25 to be inserted. In addition, a bracket (not illustrated) coupled to a body side of the vehicle is arranged in the case 12.

As illustrated in FIG. 3, the locking members 16L, 16R serving as the control mechanism are respectively arranged at positions in the vicinity of the respective through holes 13a, 13b (that is, on both left and right sides of inflator 8) on a lower portion side of the bottom wall portion 13. The locking members 16L, 16R lock the distal end portion 97b and the distal end portion 100b of the coupling members 97L, 97R and the coupling member 100 arranged on the airbag 25, respectively, and have the same configuration except that operation timings thereof are different, and thus the locking member 16L on the left side will be described as an example. As illustrated in FIG. 2, the locking member 16L includes a locking pin 17L that is inserted through a locking hole 101 formed on the distal end portion 100b of the coupling member 100 and locks the distal end portion 100b of each coupling member 100, an actuator 18L that is attached on a lower surface side of the bottom wall portion 13 and operates to be able to draw the locking pin 17L, and a support bracket 19L that is formed to extend downward from the bottom wall portion 13 on a distal end side of the locking pin 17L and is able to support the distal end side of the locking pin 17L. The actuator 18L is formed to operate to draw the locking pin 17L upon receiving an operation signal from the control device 110. When the actuator 18L operates to draw the locking pin 17L, the locking pin 17L shifts from a state of locking the distal end portion 100b side of the coupling member 100 to a state of releasing the locking. As the actuator 18L, as long as the locking pin 17L can be moved due to the electric signal from the control device 110, a piston cylinder using a hydraulic pressure, a water pressure, an air pressure, or a fluid pressure including a case where an expanding gas pressure is generated such as an inflator, a motor using the fluid pressure or electricity, an electromagnetic solenoid, a spring using a biasing force at the time of restoration, or the like can be used. When the actuator 18L is not in operation, the distal end side of the locking pin 17L is supported by the support bracket 19L so as to prevent a portion on the distal end portion 100b side of the coupling member 100 from coming off the locking pin 17L during locking.

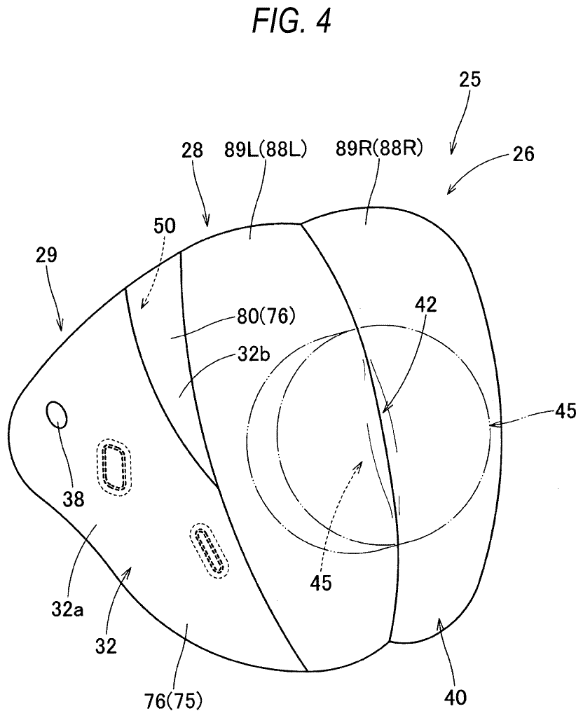

As illustrated in FIGS. 4 to 8, the airbag 25 includes a bag main body 26 including a main bag portion 28 and the subsidiary bag portion 45, the gas exhaust portion 50 provided in the main bag portion 28, tethers 60, 66L, 66R, 71, 72 that are disposed inside the bag main body 26 and regulate full inflation shapes of the main bag portion 28 and the subsidiary bag portion 45, the coupling members 97L, 97R arranged to extend from the subsidiary bag portion 45, and the coupling member 100 arranged to extend from the gas exhaust portion 50. 22 The bag main body 26 has a bag shape formed of a sheet body having flexibility, and includes the main bag portion 28, and the subsidiary bag portion 45 whose inflation is controlled by the locking member 16R serving as the control mechanism.

The main bag portion 28 is disposed so as to close between the upper surface 2 of the in-panel 1 and a windshield 4 above the in-panel 1 at the time of full inflation, and has an outer shape at the time of full inflation of a substantially quadrangular pyramid shape in which a top portion is disposed on a front end side as illustrated in FIGS. 4 to 6. The main bag portion 28 includes an occupant-side wall portion 40 arranged on a rear end 28b side at the time of full inflation, and a tapered peripheral wall portion 29 extending forward from a peripheral edge of the occupant-side wall portion 40 and converged toward the front end side.

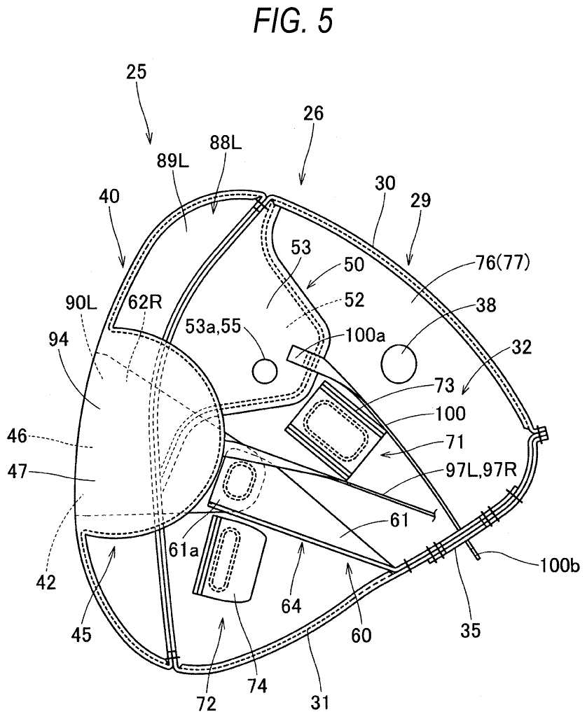

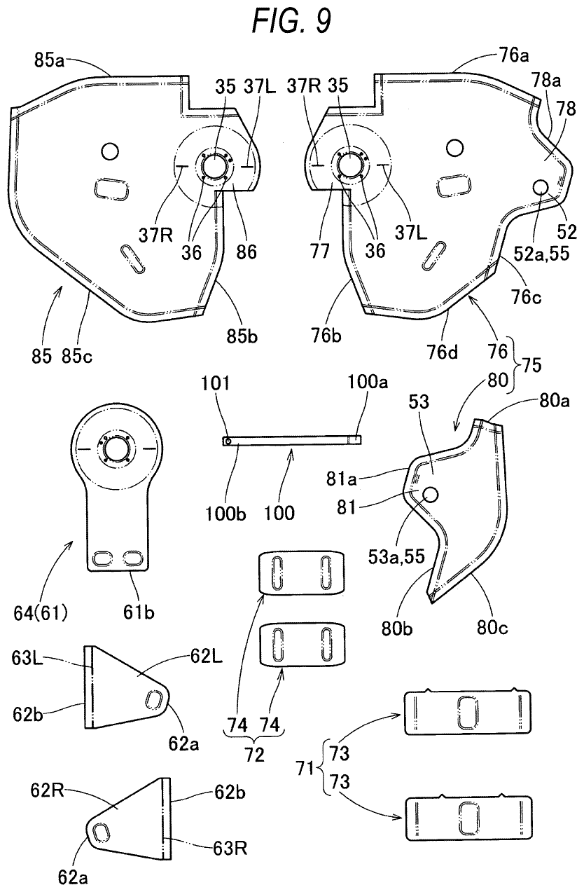

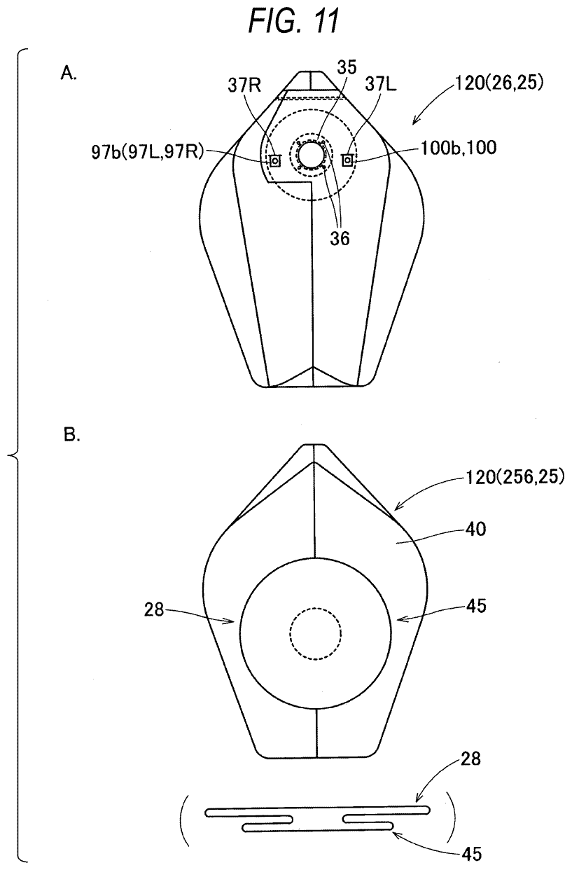

The peripheral wall portion 29 is a portion that is mainly disposed so as to close between the upper surface 2 of the in-panel 1 and the windshield 4 above the in-panel 1 at the time of full inflation of the airbag 25, and includes an upper wall portion 30 and a lower wall portion 31 that are disposed to face each other in an up-down direction, and a left wall portion 32 and a right wall portion 33 that are disposed to face each other in the left-right direction. In the vicinity of a front end of the lower wall portion 31 of the peripheral wall portion 29, which is the vicinity of a front end 28a of the main bag portion 28 at the time of full inflation, the inflow opening 35 is formed to be opened in a substantially circular shape so as to allow the inflation gas to flow into the main bag portion 28 and whose peripheral edge is attached to the bottom wall portion 13 of the case 12. A plurality of (four in the embodiment) attachment holes 36 for allowing the bolts 9a of the retainer 9 to be inserted and attaching the peripheral edge of the inflow opening 35 to the bottom wall portion 13 are formed in the peripheral edge of the inflow opening 35 (see FIG. 9 and section A in FIG. 11). On the left side of the inflow opening 35, as illustrated in FIG. 9 and section B of FIG. 11, a slit-shaped insertion hole 37L through which the distal end portion 100b of the coupling member 100 extending from the gas exhaust portion 50 can be inserted is formed substantially along the left-right direction. On the right side of the inflow opening 35, a slit-shaped insertion hole 37R through which the distal end portions 97b of the coupling members 97L, 97R extending from the subsidiary bag portion 45 can be inserted is formed substantially along the left-right direction (see FIG. 9 and section A in FIG. 11). In addition, in the left wall portion 32 and the right wall portion 33 of the peripheral wall portion 29, vent holes 38, 38 for exhausting an excess inflation gas flowing into the bag main body 26 are formed to be opened in a substantially circular shape (see FIGS. 4 and 5).

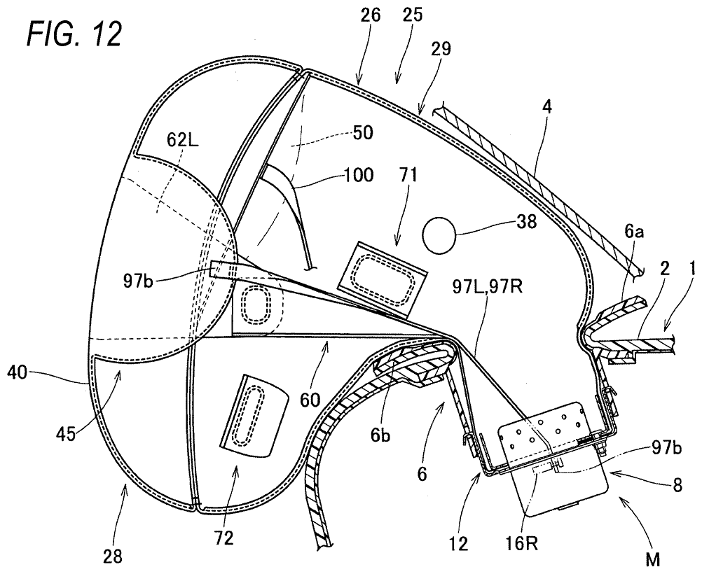

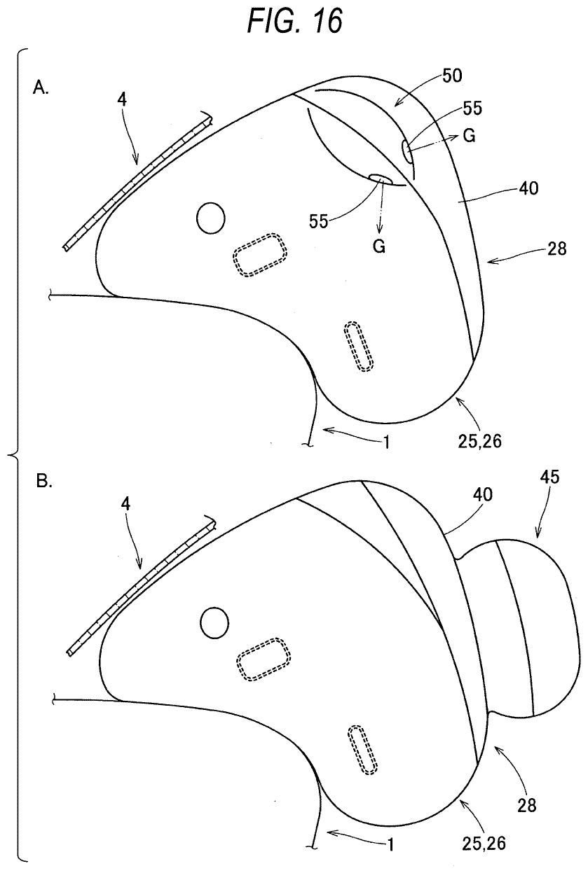

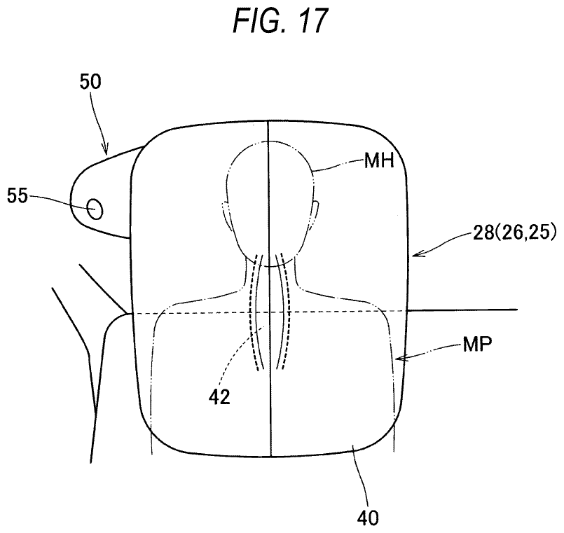

The occupant-side wall portion 40 is disposed to face the occupant MP seated in the passenger seat PS at the time of full inflation of the main bag portion 28, and is arranged along a substantially vertical direction on the rear end 28b side of the main bag portion 28 which is an occupant MP side (see FIG. 12 and section A in FIG. 16). As illustrated in FIG. 17, the outer shape of the occupant-side wall portion 40 as viewed from a rear side at the time of full inflation is a substantially rectangular shape that is wide in the up-down direction.

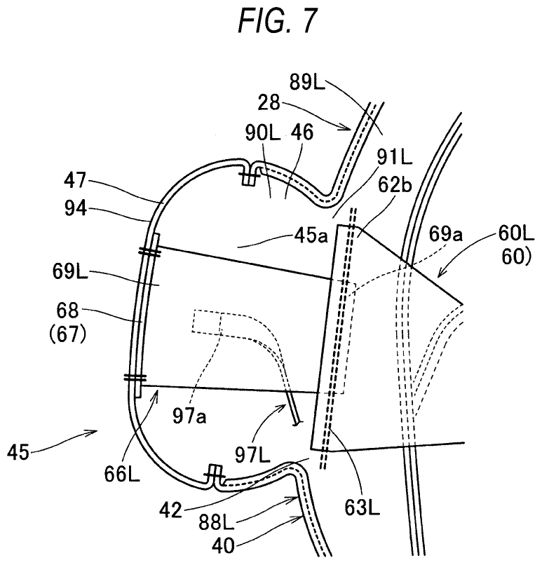

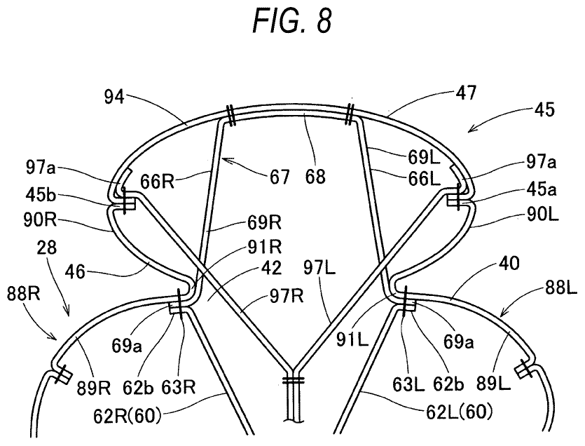

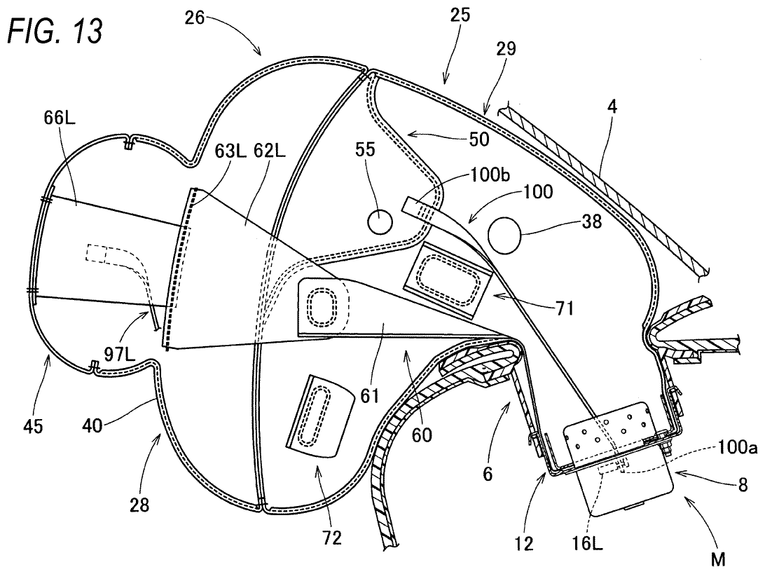

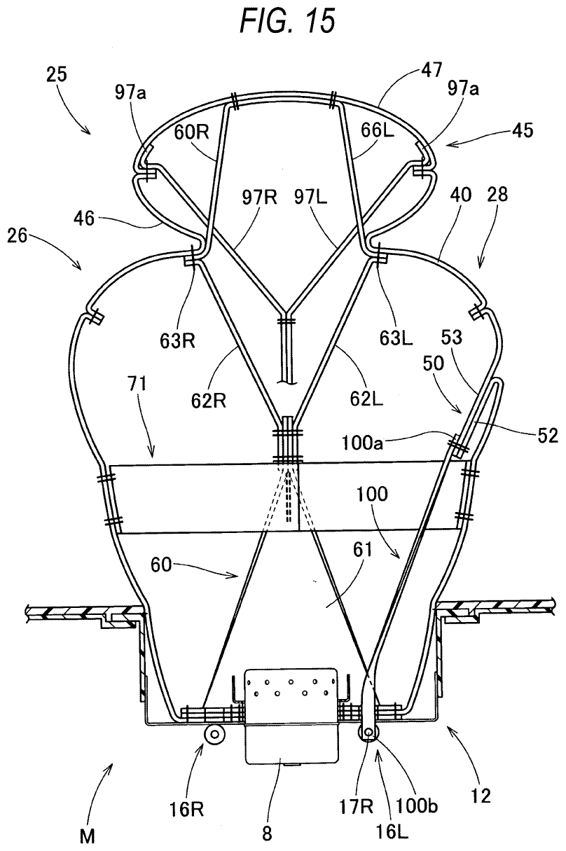

The subsidiary bag portion 45 whose inflation is controlled by the locking member 16R serving as the control mechanism communicates with the main bag portion 28 via the communication portion 42, and is disposed so as to protrude rearward from the occupant-side wall portion 40 when the entire bag main body 26 is inflated (at the time of full inflation of the airbag 25 in a state where the locking of the distal end portions 97b of the coupling members 97L, 97R by the locking member 16R is released, that is, at the time of full inflation of the airbag 25 in the large-volume mode) (see FIGS. 13 and 15). In the case of the embodiment, as illustrated in FIGS. 7 and 8, the full inflation shape of the subsidiary bag portion 45 is a substantially disk shape, and at the time of full inflation of the airbag 25 in the large-volume mode, the subsidiary bag portion 45 is disposed to protrude rearward from the occupant-side wall portion 40 such that a center in the left-right direction substantially coincides with a center of the occupant-side wall portion 40 in the left-right direction and a center in the up-down direction is positioned slightly below a center of the occupant-side wall portion 40 in the up-down direction. Specifically, an outer diameter dimension of the subsidiary bag portion 45 is set to be slightly smaller than a width dimension of the occupant-side wall portion 40 in the left-right direction. The subsidiary bag portion 45 includes a front-side wall portion 46 and a rear-side wall portion 47 having the substantially same outer shape (substantially circular shape), and is configured to be able to protect the occupant MP by the rear-side wall portion 47 constituting a rear surface side at the time of full inflation, the front-side wall portion 46 being disposed on a front surface side facing the occupant-side wall portion 40 at the time of full inflation, and the rear-side wall portion 47 being disposed on the rear surface side (occupant MP side) to face the front-side wall portion 46. As illustrated in FIGS. 7 and 8, the main bag portion 28 and the subsidiary bag portion 45 communicate with each other via the communication portion 42. In the airbag 25 according to the embodiment, the communication portion 42 is formed by boundary portions 91L, 91R between main body portions 89L, 89R and front wall forming portions 90L, 90R in a rear left panel portion 88L and a rear right panel portion 88R to be described later (see FIGS. 7, 8, and 10).

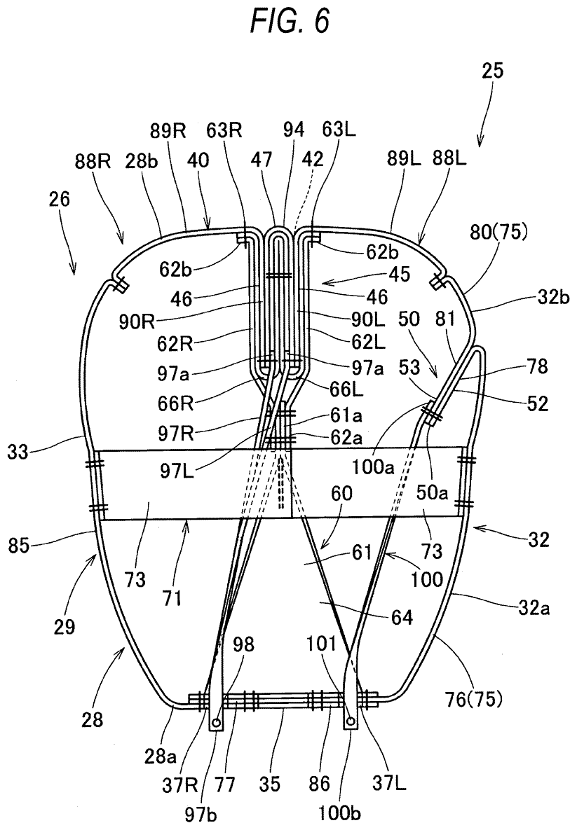

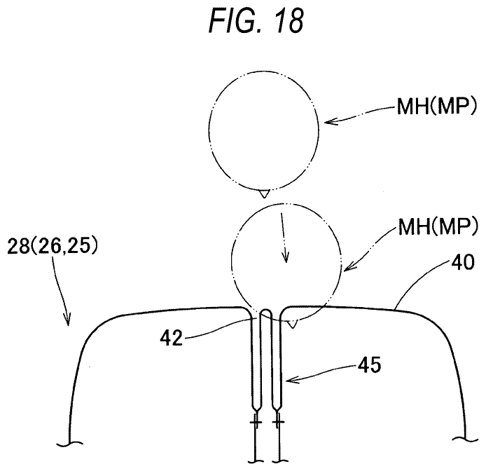

Base end portions 97 a of the coupling members 97L, 97R are coupled to a left edge 45a side and a right edge 45b side on an inner peripheral surface side of the subsidiary bag portion 45 (see FIGS. 7 and 8), and the distal end portions 97b of the coupling members 97L, 97R are locked by the locking member 16R serving as the control mechanism arranged on the bottom wall portion 13 side of the case 12 (see FIGS. 6, 12, and 14). When the main bag portion 28 is inflated in a state where the coupling between the coupling members 97L, 97R and the locking member 16R is maintained (when the airbag 25 is inflated in the small-volume mode), the subsidiary bag portion 45 is disposed so as to be drawn into the main bag portion 28 via the communication portion 42 (see FIGS. 4 to 6, 12 and 14, and section A in FIG. 16), and when the main bag portion 28 is inflated in a state where the coupling between the coupling members 97L, 97R and the locking member 16R is released (when the airbag 25 is inflated in the large-volume mode), the subsidiary bag portion 45 is inflated so as to protrude rearward from the occupant-side wall portion 40 (see FIGS. 7, 8, 13 and 15, and section B in FIG. 16). Specifically, at the time of full inflation of the airbag 25 in a state where the locking of the distal end portions 97b of the coupling members 97L, 97R by the locking member 16R is maintained (when only the main bag portion 28 is inflated and the airbag 25 is inflated in the small-volume mode), the left edge 45a side and the right edge 45b side of the subsidiary bag portion 45 are pulled forward by the coupling members 97L, 97R, and the subsidiary bag portion 45 is disposed in the main bag portion 28 substantially along the front-rear direction so as to be folded in half in the left-right direction while being entirely inverted (see FIGS. 5, 6, 12, and 14). That is, in the airbag 25 according to the embodiment, at the time of inflation in the small-volume mode, the subsidiary bag portion 45 is disposed so as to be recessed forward in a pocket shape such that a slit-shaped opening constituted by a region around the communication portion 42 is disposed in the occupant-side wall portion 40 (see FIG. 18), and in other words, at the time of inflation in the small-volume mode, as illustrated in FIGS. 4 and 17, the communication portion 42 is disposed so as to be exposed in a slit shape in the occupant-side wall portion 40 of the main bag portion 28 fully inflated. Specifically, in the case of the embodiment, the slit-shaped communication portion 42 is disposed substantially along the up-down direction at a position at substantially the center of the occupant-side wall portion 40 in the up-down and left-right directions.

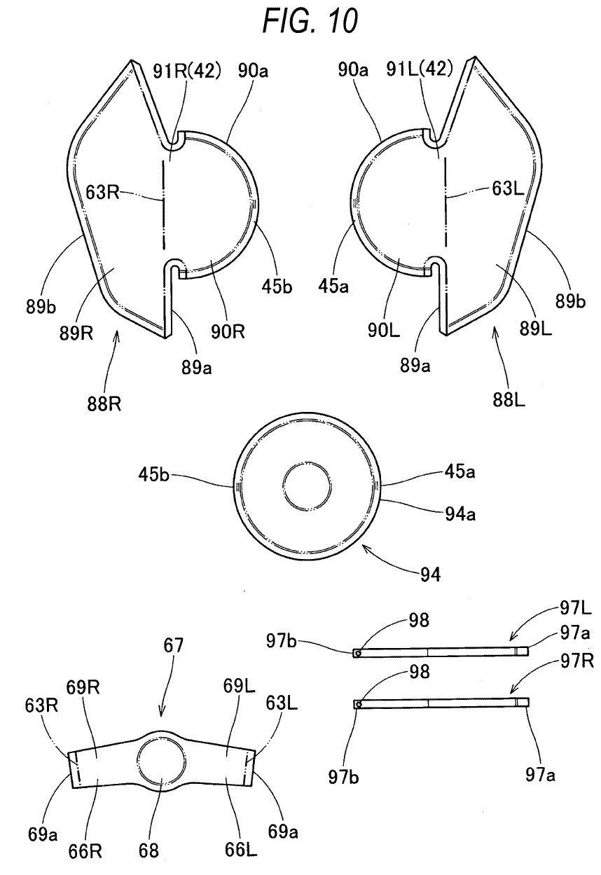

The coupling members 97L, 97R, which are arranged so as to extend from the subsidiary bag portion 45 and couple the subsidiary bag portion 45 to the locking member 16R, are formed separately from the bag main body 26 and are formed of a band-shaped fabric material having flexibility. In the case of the embodiment, the coupling members 97L, 97R are arranged as a pair of left and right coupling members extending from a left edge 45a and a right edge 45b on the inner peripheral surface side of the subsidiary bag portion 45, respectively (see FIG. 8). The base end portions 97a of the coupling member 97L, 97R are sewn to the left edge 45a and the right edge 45b respectively on the inner peripheral surface side of the subsidiary bag portion 45 (that is, positions substantially at the centers of outer peripheral edges 90a of front wall forming portions 90L, 90R to be described later), respectively. A locking hole 98 through which a locking pin 17R of the locking member 16R can be inserted is formed on the side of the distal end portion 97b of each of the coupling members 97L, 97R (see FIG. 10). In the case of the embodiment, as illustrated in FIG. 8, the respective coupling members 97L, 97R are sewn to each other at an intermediate portion. A length dimension of the coupling members 97L, 97R is set to a dimension capable of maintaining a state where the entire subsidiary bag portion 45 is drawn into the main bag portion 28 (restricting protrusion of subsidiary bag portion 45 from main bag portion 28) when the airbag 25 is inflated in a state where the locking pin 17R is inserted through the locking hole 98 and locking with the locking pin 17R is maintained.

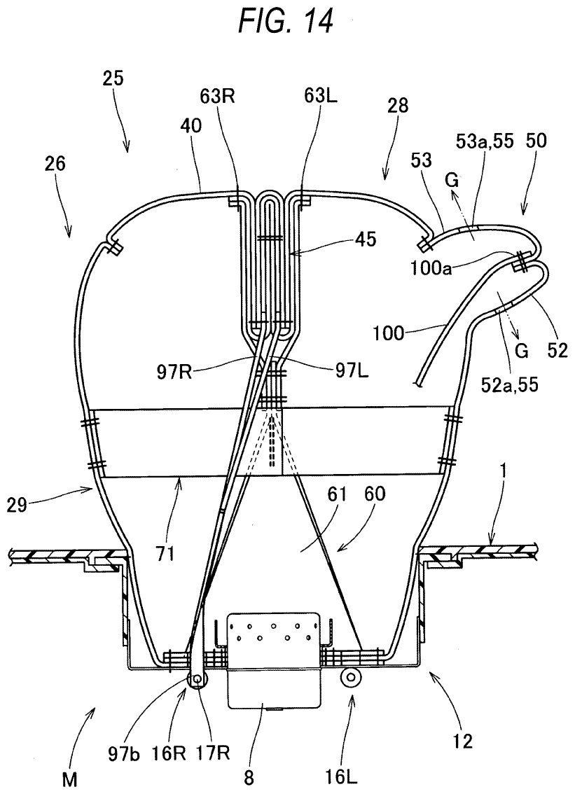

In the case of the embodiment, the gas exhaust portion 50 is disposed on a left wall portion 32 side of the main bag portion 28, and specifically, the gas exhaust portion 50 is disposed on the left wall portion 32 at a position on a rear side with respect to the vent hole 38 and a left-right tether 71 to be described later (specifically, position near rear upper end of left wall portion 32) (see FIG. 5). The gas exhaust portion 50 is formed integrally with the main bag portion 28 (bag main body 26), and has an outer shape in a side view in a flatly deployed state of a substantially trapezoidal shape narrowed toward a side of a distal end 50a (see FIG. 5). The gas exhaust portion 50 is configured such that the distal end portion 100b of the coupling member 100 extending from the distal end 50a is locked by the locking member 16L arranged on the bottom wall portion 13 side of the case 12, and when the main bag portion 28 is inflated in a state where the coupling between the coupling member 100 and the locking member 16L is maintained, the gas exhaust portion 50 is maintained in a state of being drawn into the main bag portion 28 (see FIGS. 13, 15, and 16B), and when the main bag portion 28 is inflated in a state where the coupling between the coupling member 100 and the locking member 16L is released, the gas exhaust portion 50 is released from being drawn into the main bag portion 28 and protrudes from the main bag portion 28 (see FIGS. 12 and 14, and section A in FIG. 16). Specifically, the gas exhaust portion 50 is formed to be continuous from a front-side portion 32a and a rear-side portion 32b in the left wall portion 32 of the main bag portion 28, respectively, and is configured by joining outer peripheral edges of two side wall portions 52, 53 having substantially the same outer shape. Substantially circular openings 52a, 53a are formed at positions on a lower side in the vicinity of distal ends of the side wall portions 52, 53. These openings 52a, 53a constitute exhaust holes 55 capable of exhausting an inflation gas G to the outside when protruding from the main bag portion 28 (see FIGS. 14 and 16).

The coupling member 100, which is arranged so as to extend from the gas exhaust portion 50 and couples the gas exhaust portion 50 to the locking member 16L, is formed separately from the bag main body 26 and is formed of a band-shaped fabric material having flexibility. In the coupling member 100, a base end portion 100a is sewn (joined) to the distal end 50a side of the gas exhaust portion 50 (see FIGS. 5 and 6), and the locking hole 101 through which the locking pin 17L of the locking member 16L can be inserted is provided on the distal end 100b side (see FIG. 9). The length dimension of the coupling member 100 is set to a dimension that allows the main bag portion 28 to be inflated without hindrance even when the main bag portion 28 is inflated in a state where the locking pin 17L is inserted through the locking hole 101 and locking with the locking pin 17L is maintained. Further, in the airbag device M according to the embodiment, in a case where the main bag portion 28 is inflated in a state where the coupling between the coupling member 100 and the locking member 16L is maintained, the main bag portion 28 is inflated in a state where the gas exhaust portion 50 is drawn into the main bag portion 28 by the coupling member 100, and the gas exhaust portion 50 receives an internal pressure of the inflation gas flowing into the main bag portion 28 to press the side wall portions 52, 53 around the exhaust hole 55 against each other, thereby preventing opening the exhaust hole 55 (see FIG. 15). In addition, when the main bag portion 28 is inflated in a state where the coupling between the coupling member 100 and the locking member 16L is released, the gas exhaust portion 50 is released from being drawn into the main bag portion 28, is inverted with respect to the main bag portion 28, and protrudes from the main bag portion 28, thereby opening the exhaust hole 55 (see FIG. 14).

As the tethers disposed inside the bag main body 26, front-rear tethers 60, 66L, 66R, and left-right tethers 71, 72 are disposed.

The front-rear tether 60 is arranged in the main bag portion 28, and in the case of the embodiment, the front-rear tether 60 is arranged so as to couple a front end 28a side of the main bag portion 28 and a left surface side and a right surface side of an inner peripheral surface of the communication portion 42 that allows the main bag portion 28 and the subsidiary bag portion 45 to communicate with each other. In the case of the embodiment, the front-rear tether 60 is configured to couple a front-side portion 61 extending from the

peripheral edge of the inflow opening 35 and two rear-side portions 62L, 62R respectively extending from a left inner surface and a right inner surface of the communication portion 42 (see FIGS. 5, 6, and 12 to 15). In the case of the embodiment, the front-side portion 61 is formed by folding a part of a band-shaped front-side portion material 64 illustrated in FIG. 9 such that a rear edge is along the up-down direction. Each of the rear-side portions 62L, 62R has an outer shape of a substantially trapezoidal shape expanded in the up-down direction toward a rear end 62b side (see FIG. 9). Each of the rear-side portions 62L, 62R has a front end 62a side coupled to a rear end 61a of the front-side portion 61 and the rear end 62b side coupled to a left inner surface or a right inner surface of the communication portion 42. Specifically, the rear end 62b of each of the rear-side portions 62L, 62R of the front-rear tether 60 is sewn to the boundary portions 91L, 91R between the front wall forming portions 90L, 90R and the later-described main body portions 89L, 89R of the rear left panel portion 88L and the rear right panel portion 88R serving as the occupant-side panel portion so as to form sewn portions 63L, 63R (see FIGS. 7, 8, 10, and 15). The front-rear tether 60 couples the vicinity (communication portion 42) of a center of the occupant-side wall portion 40 in the up-down and left-right directions and a peripheral edge portion of the inflow opening 35 at the time of full inflation of the main bag portion 28, and is arranged to prevent excessive rearward protrusion of the occupant-side wall portion 40 at an initial stage of inflation of the airbag 25 and rearward movement of the occupant-side wall portion 40 (increase in separation distance between vicinity of inflow opening 35 and occupant-side wall portion 40) at the time of full inflation.

The front-rear tethers 66L, 66R are arranged inside the subsidiary bag portion 45, and the two tethers are arranged in the left-right direction so as to couple the rear-side wall portion 47 and a front-side wall portion 46 side in the subsidiary bag portion 45 (specifically, left inner surface or right inner surface of communication portion 42). In the case of the embodiment, the front-rear tethers 66L, 66R are formed by a front-rear tether base material 67 as illustrated in FIG. 10. The front-rear tether base material 67 includes a circular attachment portion 68 and band-shaped tether forming portions 69L, 69R extending in the left-right direction from the attachment portion 68, and is formed such that the attachment portion 68 is disposed such that a center thereof coincides with a center of the rear-side wall portion 47, an outer peripheral edge 68a is sewn to the rear-side wall portion 47, distal ends 69a of the respective tether forming portions 69L, 69R are sewn together with rear ends 62b of rear-side portions 62L, 62R of the front-rear tether 60 at portions of the sewn portions 63L, 63R so as to be coupled to the left inner surface or the right inner surface of the communication portion 42. The front-rear tethers 66L, 66R (tether forming portions 69L, 69R in front-rear tether base material 67) are disposed to be inclined with respect to the front-rear direction such that front ends thereof are positioned on outer sides in the left-right direction in a state where the subsidiary bag portion 45 at the time of full inflation is viewed in the up-down direction (see FIG. 8). The front-rear tethers 66L, 66R are arranged to prevent excessive rearward protrusion of the rear-side wall portion 47 of the subsidiary bag portion 45 at the initial stage of inflation of the airbag 25 and rearward movement of the rear-side wall portion 47 at the time of full inflation (increase in separation distance between front-side wall portion 46 and rear-side wall portion 47) when the airbag 25 is inflated in the large-volume mode.

In the case of the embodiment, as illustrated in FIGS. 5 and 6, the left-right tethers 71, 72 are disposed at two positions above and below the front-rear tether 60 in the main bag portion 28, and couple the left wall portion 32 and the right wall portion 33, respectively, and are arranged substantially along the left-right direction at the time of full inflation of the main bag portion 28. The left-right tether 71 disposed on an upper side is formed by two band-shaped tether base materials 73, 73 (see FIG. 9), and although not illustrated in detail, the left-right tether 71 is formed by sewing centers of the band-shaped tether base materials 73, 73 in a state where a width direction thereof is substantially along the front-rear direction to the left wall portion 32 or the right wall portion 33, and sewing four distal ends to each other in an overlapping manner. The left-right tether 72 disposed on a lower side is also formed by two band-shaped tether base materials 74, 74 (see FIG. 9), and although not illustrated in detail, the left-right tether 72 is formed by sewing one end side of each of the tether base materials 74, 74 in a state where a width direction is substantially along the up-down direction to the left wall portion 32 or the right wall portion 33, and sewing the other ends to each other. The left-right tethers 71, 72 are arranged in order to prevent the left wall portion 32 and the right wall portion 33 from being excessively separated from each other in the initial stage of inflation and to prevent an increase in a width dimension (separation distance between left wall portion and right wall portion) of the main bag portion 28 in the left-right direction at the time of full inflation.

The bag main body 26 and the gas exhaust portion 50 in the airbag 25 are formed in an integrated bag shape by joining peripheral edges of base materials having a predetermined shape to each other. In the case of the embodiment, as illustrated in FIGS. 9 and 10, the bag main body 26 and the gas exhaust portion 50 include a left panel portion 75, a right panel portion 85, the rear left panel portion 88L and the rear right panel portion 88R serving as an occupant-side panel portion, and a rear panel portion 94.

The left panel portion 75 and the right panel portion 85 mainly form a region of the peripheral wall portion 29 in the main bag portion 28, and specifically, divide the peripheral wall portion 29 into two in the left-right direction to form a left-side region and a right-side region, respectively. The left panel portion 75 forms the left-side region of the peripheral wall portion 29 and the gas exhaust portion 50, and specifically, extends from a left half region of the upper wall portion 30 in the peripheral wall portion 29 to a left half region of the lower wall portion 31 via the left wall portion 32. The right panel portion 85 forms a right-side region of the peripheral wall portion 29, and specifically, extends from a right half region of the upper wall portion 30 in the peripheral wall portion 29 to a right half region of the lower wall portion 31 via the right wall portion 33. The left panel portion 75 and the right panel portion 85 respectively have protruding portions 77, 86 forming a region of the peripheral edge of the inflow opening 35. As illustrated in FIG. 9, the left panel portion 75 is divided into two in the front-rear direction, and includes a front-side portion 76 and a rear-side portion 80. The front-side portion 76 includes the protruding portion 77 forming the region of the peripheral edge of the inflow opening 35, and an exhaust portion forming portion 78 forming the side wall portion 52 of the gas exhaust portion 50 partially protrudes toward a rear upper edge 76c side. In the rear-side portion 80, an exhaust portion forming portion 81 forming the side wall portion 53 of the gas exhaust portion 50 partially protrudes toward a front edge 80b side. An outer shape of the right panel portion 85 is substantially the same as an outer shape of the left panel portion 75 in a state where a rear upper edge 76c of the front-side portion 76 and a front edge 80b of the rear-side portion 80 are sewn together.

The rear left panel portion 88L and the rear right panel portion 88R mainly form the occupant-side wall portion 40 of the main bag portion 28 as occupant-side panel portions, and are formed to divide the occupant-side wall portion 40 into two in the left-right direction. Specifically, as illustrated in FIG. 10, the rear left panel portion 88L includes the main body portion 89L forming a left-side region of the occupant-side wall portion 40, and the front wall forming portion 90L formed to protrude from an inner edge 89a (edge portion forming central region of occupant-side wall portion 40) of the main body portion 89L. The front wall forming portion 90L forms the front-side wall portion 46 of the subsidiary bag portion 45, and is formed to partially protrude from the inner edge 89a of the main body portion 89L. Specifically, the front wall forming portion 90L forms a left half region of the front-side wall portion 46 of the subsidiary bag portion 45, and has an outer shape of a substantially semicircular shape. Further, in the airbag 25 according to the embodiment, the boundary portion 91L between the main body portion 89L and the front wall forming portion 90L of the rear left panel portion 88L forms the communication portion 42 that allows the main bag portion 28 and the subsidiary bag portion 45 to communicate with each other. An outer edge 89b of the main body portion 89L of the rear left panel portion 88L has an outer shape substantially matching those of a rear lower edge 76d and a rear edge 80c of the left panel portion 75. In the case of the embodiment, since the rear left panel portion 88L and the rear right panel portion 88R are bilaterally symmetrical, regarding the rear right panel portion 88R, “R” is added to an end of the same reference numeral and detailed description thereof will be omitted. The rear panel portion 94 forms the rear-side wall portion 47 of the subsidiary bag portion 45, and has an outer shape of a circular shape. That is, the rear panel portion 94 is formed to have an outer shape substantially the same as a shape in a state where each of the front wall forming portions 90L, 90R in each of the rear left panel portion 88L and the rear right panel portion 88R are opened in a state where the inner edges 89a, 89a are joined to each other.

In the embodiment, the left panel portion 75 (front-side portion 76 and rear-side portion 80), the right panel portion 85, the rear left panel portion 88L, the rear right panel portion 88R, and the rear panel portion 94, the front-rear tethers 60, 66L, 66R, the front-side portion material 64 forming the left-right tethers 71, 72, the rear-side portions 62L, 62R, the front-rear tether base material 67, and the tether base materials 73, 74 that form the bag main body 26 and the gas exhaust portion 50 are each formed of a flexible woven fabric made of polyester yarn, polyamide yarn, or the like. In addition, in the embodiment, the coupling members 97L, 97R, 100 are also formed of a flexible woven fabric made of polyester yarn, polyamide yarn, or the like similarly to the bag main body 26.

The bag main body 26 according to the embodiment is formed in a bag shape having the gas exhaust portion 50 by sewing (joining) corresponding edge portions of the left panel portion 75 (front-side portion 76 and rear-side portion 80), the right panel portion 85, the rear left panel portion 88L, the rear right panel portion 88R, and the rear panel portion 94 to each other using a sewing thread. The front-side portion 76 and the rear-side portion 80 of the left panel portion 75 are sewn to each other at the corresponding rear upper edge 76c and front edge 80b, including the outer peripheral edges 78a, 81a of the exhaust portion forming portions 78, 81. Upper edges 76a, 80a of the front-side portion 76 and the rear-side portion 80 of the left panel portion 75 are sewn to an upper edge 85a of the right panel portion 85. A lower edge 76b of the front-side portion 76 of the left panel portion 75 is sewn to a lower edge 85b of the right panel portion 85. The rear lower edge 76d of the front-side portion 76 and the rear edge 80c of the rear-side portion 80 of the left panel portion 75 are sewn to the outer edge 89b of the main body portion 89L of the rear left panel portion 88L. A rear edge 85c of the right panel portion 85 is sewn to an outer edge 89b of the main body portion 89R of the rear right panel portion 88R. The inner edge 89a of the main body portion 89L of the rear left panel portion 88L is sewn to the inner edge 89a of the main body portion 89R of the rear right panel portion 88R. The outer peripheral edge 90a of the front wall forming portion 90L of the rear left panel portion 88L is sewn to the left half of an outer peripheral edge 94a of the rear panel portion 94, and the outer peripheral edge 90a of the front wall forming portion 90R of the rear right panel portion 88R is sewn to the right half of the outer peripheral edge 94a of the rear panel portion 94.

Next, mounting of the airbag device M according to the embodiment on the vehicle will be described. First, the airbag 25 is folded so as to be stored in the case 12 in a state where the retainer 9 is stored inside. Although not illustrated in detail, the airbag 25 is folded so as to reduce width dimensions in the front-rear and left-right directions from a state of a preliminary folded bag 120 as illustrated in sections A and B of FIG. 11. In the preliminary folded bag 120 in which the airbag 25 (bag main body 26) is preliminarily folded, as illustrated in sections A and B of FIG. 11, the occupant-side wall portion 40 is brought close to an inflow opening 35 side (disposed on inflow opening 35) while the occupant-side wall portion 40 is deployed substantially flat, a valley fold is formed in a portion of the peripheral wall portion 29, the main bag portion 28 is folded, and the subsidiary bag portion 45 in a state of being flatly deployed such that the front-side wall portion 46 and the rear-side wall portion 47 overlap each other is overlapped on an upper side of the occupant-side wall portion 40 in the main bag portion 28. That is, in the airbag 25 according to the embodiment, in the state of the preliminary folded bag 120, the subsidiary bag portion 45 is overlapped on the main bag portion 28 so as not to be inserted into the main bag portion 28 but to be exposed from the main bag portion 28. Then, such a preliminary folded bag 120 is folded so as to reduce the width dimensions in the front-rear and left-right directions, and a periphery of the formed folded-up body is wrapped with a breakable wrapping sheet (not illustrated) so as to avoid folding collapse. In this case, the distal end portions 97b of the coupling members 97L, 97R extending from the subsidiary bag portion 45 and the distal end portion 100b of the coupling member 100 extending from the gas exhaust portion 50 protrude from the insertion holes 37L, 37R formed in the bag main body 26, respectively. Then, the folded airbag 25 is stored in the case 12 to which the locking members 16L, 16R are attached in advance such that the bolts 9a protrude from the bottom wall portion 13. Then, the locking pin 17L of the locking member 16L is inserted through the locking hole 101 of the coupling member 100 protruding from the through hole 13a formed in the bottom wall portion 13, and the distal end portion 100b of the coupling member 100 is locked by the locking member 16L such that the distal end of the locking pin 17L is supported by the support bracket 19L. Similarly, the distal end portions 97b of the coupling members 97L, 97R protruding from the through hole 13b of the bottom wall portion 13 is locked by the locking member 16R. Next, the main body portion 8a of the inflator 8 is inserted into the case 12 from below the bottom wall portion 13, and the bolts 9a of the retainer 9 protruding downward from the bottom wall portion 13 are inserted through the flange portion 8c of the inflator 8. Thereafter, by fastening the nuts 10 to the bolts 9a protruding from the flange portion 8c of the inflator 8, the folded airbag 25 and the inflator 8 can be attached to the case 12.

Thereafter, the peripheral wall portion 14 of the case 12 is locked to the coupling wall portion 6c of the airbag cover 6 in the in-panel 1 mounted on the vehicle, the bracket (not illustrated) provided on the case 12 is fixed to the body side of the vehicle, and the inflator 8 and the locking members 16L, 16R are electrically connected to the control device 110, thereby enabling the airbag device M to be mounted on the vehicle.

When a front surface collision of the vehicle is detected after the airbag device M is mounted on the vehicle, the control device 110 outputs an operation signal to the inflator 8, the inflator 8 discharges the inflation gas from the gas discharge port 8b, the airbag 25 is inflated by causing the inflation gas to flow into the airbag 25, and the door portions 6a, 6b of the airbag cover 6 are pushed open. Then, the airbag 25 protrudes upward from the case 12 through an opening formed by push opening the door portions 6a, 6b of the airbag cover 6 to open, and is deployed and inflated while protruding toward the rear side of the vehicle, thereby completing the inflation so as to close between the upper surface 2 of the in-panel 1 and the windshield 4 above the in-panel 1 as indicated by a two-dot chain line in FIG. 1 and as illustrated in FIGS. 12, 13 and 17, and as illustrated in sections A and B of FIG. 16.

In the airbag device M according to the embodiment, the airbag 25 includes the main bag portion 28, and the subsidiary bag portion 45 whose inflation is controlled by the locking member 16R serving as the control mechanism. The subsidiary bag portion 45 whose inflation is controlled by the locking member 16R serving as the control mechanism is formed to be coupled to the locking member 16R by the coupling members 97L, 97R, and is formed to be in a non-inflated state where the subsidiary bag portion 45 is drawn into the main bag portion 28 through the communication portion 42 when the coupling between the coupling members 97L, 97R and the locking member 16R is maintained, and to be inflated so as to protrude rearward from the occupant-side wall portion 40 disposed on the rear end side of the main bag portion 28 by causing the inflation gas to flow into the inside through the main bag portion 28 and the communication portion 42 when the coupling between the coupling members 97L, 97R and the locking member 16R is released. That is, in the airbag device M according to the embodiment, since the inflation of the subsidiary bag portion 45 is controlled only by maintaining or releasing the coupling state between the locking member 16R serving as the control mechanism and the coupling members 97L, 97R extending from the subsidiary bag portion 45, it is possible to prevent variation in an inflation timing of the subsidiary bag portion 45 even in a case where the subsidiary bag portion 45 is inflated in addition to the main bag portion 28. In the airbag device M according to the embodiment, in a case where the airbag 25 is fully inflated in a state where the coupling between the coupling members 97L, 97R and the locking member 16R is maintained, the subsidiary bag portion 45 is not exposed to the outside in a state of being drawn into the main bag portion 28, and the occupant MP can be properly received by the occupant-side wall portion 40 of the main bag portion 28 fully inflated, and in a case where the airbag 25 is fully inflated in a state where the coupling between the coupling members 97L, 97R and the locking member 16R is released, the occupant MP can be properly received by a rear surface (rear-side wall portion 47) of the subsidiary bag portion 45 that is inflated so as to protrude rearward from the main bag portion 28.

Therefore, in the airbag device M according to the embodiment, even when the airbag device M is configured to have different inflation modes, the occupant MP can be stably protected by the airbag 25 fully inflated.

Specifically, in the airbag device M according to the embodiment, in a case where the control device 110 that inputs a signal from predetermined sensors 111, 112, 113 detects, for example, that an occupant MP1 of a small physique is seated or that the occupant MP is seated at a position close to the in-panel 1, the airbag 25 is inflated in a state where an operation signal is output to the actuator 18L of the locking member 16L substantially simultaneously with the operation of the inflator 8. That is, no operation signal is output to the actuator 18R of the locking member 16R, and the airbag 25 is inflated in a state where the coupling state between the coupling members 97L, 97R extending from the subsidiary bag portion 45 and the locking member 16R is maintained, and only the main bag portion 28 is fully inflated in the small-volume mode (see FIGS. 12, 14 and 17, and section A in FIG. 16). In this case, since the coupling between the coupling member 100 extending from the gas exhaust portion 50 and the locking member 16L is released by the operation of the actuator 18L, an excess inflation gas G can be exhausted from the gas exhaust portion 50 protruding from the main bag portion 28. Therefore, the occupant MP1 of a small physique and the

occupant MP seated close to the in-panel 1 can be properly received by the occupant-side wall portion 40 of the inflated main bag portion 28 that is inflated while exhausting the excess inflation gas G from the gas exhaust portion 50.

In contrast, for example, in a case where the control device 110 detects that an occupant MP2 of a large physique is seated or detects that the occupant MP is seated at a position away from the in-panel 1, in the airbag device M according to the embodiment, the airbag 25 is inflated in a state where the operation signal is output to the actuator 18R of the locking member 16R substantially simultaneously with the operation of the inflator 8. That is, the airbag 25 is inflated in a state where the coupling state between the coupling members 97L, 97R extending from the subsidiary bag portion 45 and the locking member 16R is released, and the main bag portion 28 and the subsidiary bag portion 45 are fully inflated in the large-volume mode (see FIGS. 13 and 15, and section B in FIG. 16). In this case, no operation signal is output to the locking member 16L, the airbag 25 is inflated in a state where the coupling state between the coupling member 100 extending from the gas exhaust portion 50 and the locking member 16L is maintained, and the gas exhaust portion 50 is drawn into the main bag portion 28 to maintain a closed state of the exhaust hole 55. Therefore, excessive exhaustion of the inflation gas G can be prevented, internal pressures of the main bag portion 28 and the subsidiary bag portion 45 can be maintained, and the occupant MP2 of a large physique and the occupant MP seated away from the in-panel 1 can be properly received by the rear-side wall portion 47 of the subsidiary bag portion 45 protruding rearward from the occupant-side wall portion 40.

In the airbag device M according to the embodiment, the occupant-side wall portion 40 of the main bag portion 28 is formed by two occupant-side panel portions (rear left panel portion 88L and rear right panel portion 88R) dividing the occupant-side wall portion 40 into two in the left-right direction, and in the rear left panel portion 88L and the rear right panel portion 88R, the front wall forming portions 90L, 90R constituting a half region of the front-side wall portion 46 in the subsidiary bag portion 45 are formed to protrude from the edge portions (inner edges 89a of main body portions 89L, 89R) that form the central region of the occupant-side wall portion 40 and are joined to each other. In addition, the rear panel portion 94 constituting the rear-side wall portion 47 of the subsidiary bag portion 45 is formed to have an outer shape substantially the same as a shape in a state where each of the front wall forming portions 90L, 90R in each of the rear left panel portion 88L and the rear right panel portion 88R are opened in a state where the inner edges 89a, 89a are joined to each other. Therefore, in the rear left panel portion 88L and the rear right panel portion 88R in a state where the corresponding inner edges 89a, 89a are joined to each other, when the outer peripheral edges 90a of the front wall forming portions 90L, 90R and the outer peripheral edge 94a of the rear panel portion 94 are joined to each other, the occupant-side wall portion 40 of the main bag portion 28 can be formed, and at the same time, the subsidiary bag portion 45 can be formed. That is, in the airbag 25 according to the embodiment, since the occupant-side wall portion 40 of the main bag portion 28 and the subsidiary bag portion 45 can be formed by a planar joining operation, the airbag 25 can be easily manufactured. In the airbag 25 according to the embodiment, since the entire main bag portion 28 can also be manufactured by a planar joining operation in addition to the subsidiary bag portion 45, an increase in manufacturing cost can be prevented, and manufacturing can be performed at a low cost.

In the airbag device M according to the embodiment, the subsidiary bag portion 45 is formed by joining the outer peripheral edges of the front-side wall portion 46 and the rear-side wall portion 47 having substantially the same outer shape to each other, and the coupling members 97L, 97R are formed so as to extend from inner peripheral surface sides of the left edge 45a and the right edge 45b (that is, positions substantially at the centers of the outer peripheral edges 90a of the respective front wall forming portions 90L, 90R) which are two portions facing each other in a direction along the dividing direction of the occupant-side wall portion 40 on the outer peripheral edge of the subsidiary bag portion 45. Therefore, when the main bag portion 28 is inflated in a state where the coupling between the coupling members 97L, 97R and the locking member 16R is maintained, the subsidiary bag portion 45 is disposed in the main bag portion 28 so as to be pulled by the coupling members 97L, 97R and folded in half while being entirely inverted. In other words, in a state where the coupling between the coupling members 97L, 97R and the locking member 16R is maintained, the subsidiary bag portion 45 is not bulky in the main bag portion 28, and is disposed so as to be recessed forward in a pocket shape from the occupant-side wall portion 40 such that a slit-shaped opening formed by a region around the communication portion 42 is disposed in the occupant-side wall portion 40, and thus it is possible to stably inflate only the main bag portion 28 without affecting the inflation shape of the main bag portion 28.

Further, in the airbag device M according to the embodiment, the airbag 25 is stored in the case 12 in a state of a folded-up body in which the preliminary folded bag 120 is folded so as to be reduced in the front-rear and left-right directions, and in the preliminary folded bag 120, the subsidiary bag portion 45 is disposed on the occupant-side wall portion 40 of the main bag portion 28 in a state of being flatly deployed such that the front-side wall portion 46 and the rear-side wall portion 47 overlap each other. That is, in the airbag device M according to the embodiment, the airbag 25 is folded in a state where the subsidiary bag portion 45 is exposed to the outside of the main bag portion 28, and is stored in the case 12. Therefore, when the airbag 24 is inflated in a state where the coupling between the coupling members 97L, 97R and the locking member 16R is released, the subsidiary bag portion 45 is inflated by causing the inflation gas to flow into the subsidiary bag portion 45 from a state where the subsidiary bag portion 45 is exposed to the rear surface side of the main bag portion 28, and thus the subsidiary bag portion 45 can be inflated quickly and smoothly. If such a viewpoint is not taken into consideration, the airbag may be folded in a state where the subsidiary bag portion is inserted into the main bag portion.

In the embodiment, since the airbag 25 is folded in a state where the subsidiary bag portion 45 is exposed to the outside of the main bag portion 28, and is stored in the case 12, when the main bag portion 28 is inflated in a state where the coupling state between the coupling members 97L, 97R and the locking member 16R is maintained, the subsidiary bag portion 45 is inserted into the main bag portion 28 through the communication portion 42 with the inflation of the main bag portion 28 (rearward movement of occupant-side wall portion 40). In the airbag 25 according to the embodiment, the width dimensions of the boundary portions 91L, 91R of the rear left panel portion 88L and the rear right panel portion 88R constituting the communication portion 42 are slightly smaller than outer diameter dimensions of the front wall forming portions 90L, 90R and are set to substantially the same dimension, in other words, a length dimension of the communication portion 42 in a flatly deployed state is substantially the same as the outer diameter dimension of the subsidiary bag portion 45. Therefore, when the inflation is performed in the small-volume mode, the subsidiary bag portion 45 pulled by the coupling members 97L, 97R can be prevented from being partially caught in the communication portion 42, and can be smoothly inserted into the main bag portion 28.

Further, in the airbag device M according to the embodiment, the occupant-side panel portions (rear left panel portion 88L and rear right panel portion 88R) are formed to divide the occupant-side wall portion 40 into two in the left-right direction. Therefore, at the time of full inflation of the main bag portion 28 in a state where the coupling between the coupling members 97L, 97R and the locking member 16R is maintained, the subsidiary bag portion 45 disposed in a pocket shape so as to be recessed forward from the occupant-side wall portion 40 is disposed such that the slit-shaped opening on the rear end side is substantially along the up-down direction in the occupant-side wall portion 40 (see FIG. 17). As a result, in a case where only the main bag portion 28 is inflated, as illustrated in FIG. 18, it is possible to protect a head portion MH of the occupant MP by allowing the head portion MH to enter the pocket-shaped region (slit-shaped opening formed in occupant-side wall portion 40 along up-down direction). In addition, in the airbag 25 according to the embodiment, by changing the positions of the front wall forming portions 90L, 90R in the up-down

direction with respect to the main body portions 89L, 89R of the rear left panel portion 88L and the rear right panel portion 88R, the position of the subsidiary bag portion 45 in the up-down direction with respect to the main bag portion 28 (occupant-side wall portion 40) can be easily adjusted as necessary.

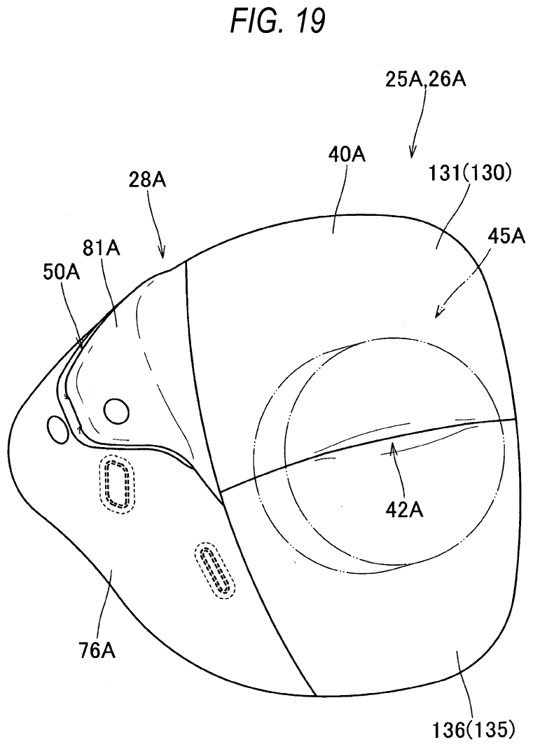

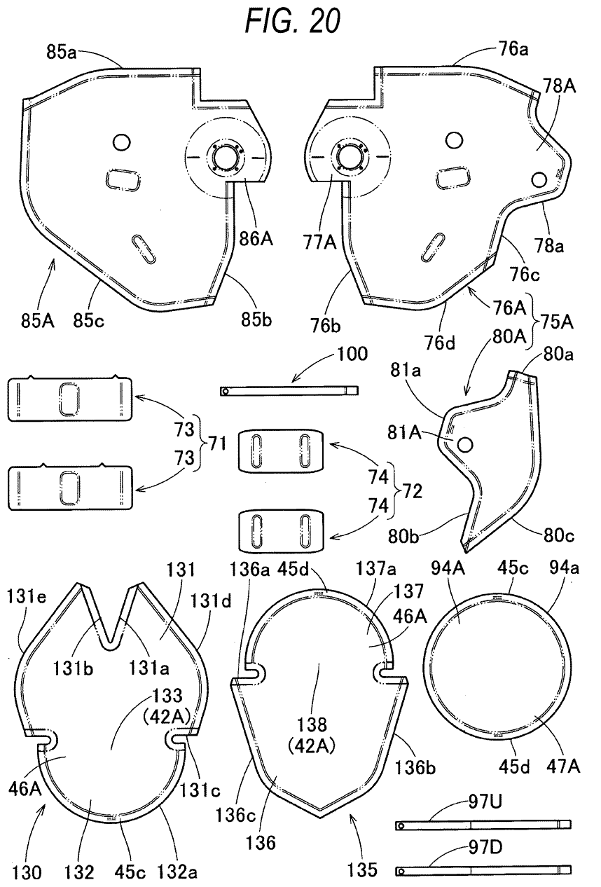

If such a viewpoint is not taken into consideration, an airbag having a configuration as illustrated in FIG. 19 may be used as an airbag 25A. The airbag 25A has substantially the same configuration as that of the airbag 25 described above except that an occupant-side wall portion 40A is configured by two panel portions of a rear upper panel portion 130 and a rear lower panel portion 135 (occupant-side panel portion) dividing the occupant-side wall portion 40A into two in the up-down direction, and the same members are denoted by the same reference numerals with A added at the end thereof, and detailed description thereof will be omitted. The airbag 25A is not provided with a front-rear tether, and coupling members 97U, 97D extending from a subsidiary bag portion 45A are coupled to an upper edge 45c side and a lower edge 45d side on an inner peripheral surface side of the subsidiary bag portion 45A at the side of the base end portion 97a (see FIG. 20).

As illustrated in FIGS. 19 and 20, the rear upper panel portion 130 and the rear lower panel portion 135 serving as the occupant-side panel portion mainly form the occupant-side wall portion 40A in a main bag portion 28A, and are formed to divide the occupant-side wall portion 40A into two in the up-down direction. The rear upper panel portion 130 includes a main body portion 131 forming an upper-side region of the occupant-side wall portion 40A, and a front wall forming portion 132 formed to protrude from a lower edge 131c of the main body portion 131 (inner edge constituting central region of occupant-side wall portion 40A). The front wall forming portion 132 forms an upper half region of a front-side wall portion 46A of the subsidiary bag portion 45A, and has an outer shape of a substantially semicircular shape. The rear lower panel portion 135 includes a main body portion 136 forming a lower-side region of the occupant-side wall portion 40A, and a front wall forming portion 137 formed to protrude from an upper edge 136a of the main body portion 136 (inner edge constituting central region of occupant-side wall portion 40A). The front wall forming portion 137 forms a lower half region of the front-side wall portion 46A of the subsidiary bag portion 45A, and has an outer shape of a substantially semicircular shape. Also in the airbag 25A, a boundary portion 133 between the main body portion 131 and the front wall forming portion 132 of the rear upper panel portion 130 and a boundary portion 138 between the main body portion 136 and the front wall forming portion 137 of the rear lower panel portion 135 form a communication portion 42A that allows the main bag portion 28A and the subsidiary bag portion 45A to communicate with each other.

A bag main body 26A in the airbag 25A is also formed into a bag shape having a gas exhaust portion 50A by sewing (joining) corresponding edge portions of a left panel portion 75A (front-side portion 76A and rear-side portion 80A), a right panel portion 85A, the rear upper panel portion 130, the rear lower panel portion 135, and a rear panel portion 94A to each other using a sewing thread. In the rear upper panel portion 130, an upper inner left edge 131a and an upper inner right edge 131b of the main body portion 131 are sewn to each other. The lower edge 131c (inner edge) of the main body portion 131 is sewn to the upper edge 136a (inner edge) of the main body portion 136 in the rear lower panel portion 135. A left edge 131d of the main body portion 131 is sewn to the rear lower edge 76d of the front-side portion 76A and the rear edge 80c of the rear-side portion 80A of the left panel portion 75A together with a left edge 136b of the main body portion 136 of the rear lower panel portion 135. A right edge 131 e of the main body portion 131 is sewn to the rear edge 85 c of the right panel portion 85A together with a right edge 136c of the main body portion 136 of the rear lower panel portion 135. An outer peripheral edge 132a of the front wall forming portion 132 is sewn to the upper half of the outer peripheral edge 94a of the rear panel portion 94A, and an outer peripheral edge 137a of the front wall forming portion 137 is sewn to the lower half of the outer peripheral edge 94a of the rear panel portion 94A.

Also in the airbag 25A having such a configuration, since the occupant-side wall portion 40A of the main bag portion 28A and the subsidiary bag portion 45A can be formed by a planar joining operation, the airbag 25A can be easily manufactured. Also in the airbag 25A having the above configuration, since the entire main bag portion 28A can also be manufactured by a planar joining operation, an increase in manufacturing cost can be prevented, and manufacturing can be performed at a low cost.

Further, also in the airbag 25A having the above configuration, the subsidiary bag portion 45A is formed by joining outer peripheral edges of the front-side wall portion 46A and the rear-side wall portion 47A having substantially the same outer shape to each other, and the coupling members 97U, 97D are formed so as to extend from an inner peripheral surface side of the upper edge 45c and the lower edge 45d (that is, positions substantially at centers of outer peripheral edges 132a, 137a of respective front wall forming portions 132, 137) which are two portions facing each other in a direction along a dividing direction of the occupant-side wall portion 40A on the outer peripheral edge of the subsidiary bag portion 45A. Therefore, when the main bag portion 28A is inflated in a state where coupling between the coupling members 97U, 97D and a locking member (not illustrated) is maintained, although not illustrated in detail, the subsidiary bag portion 45A is disposed in the main bag portion 28A so as to be pulled by the coupling members 97U, 97D and folded in half while being entirely inverted. In other words, in a state where the coupling between the coupling members 97U, 97D and the locking member is maintained, the subsidiary bag portion 45A is not bulky in the main bag portion 28A, and is disposed so as to be recessed forward in a pocket shape from the occupant-side wall portion 40A such that a slit-shaped opening formed by a region around the communication portion 42A is disposed in the occupant-side wall portion 40A along the left-right direction, and thus it is possible to stably inflate only the main bag portion 28A without affecting the inflation shape of the main bag portion 28A.

The airbags 25, 25A according to the embodiment are configured to have the gas exhaust portions 50, 50A capable of exhausting the inflation gas by being controlled to open and close by the locking member 16L serving as the control mechanism, thereby adjusting the internal pressure at the time of full inflation. Therefore, the occupant can be received with an appropriate internal pressure both during inflation in the small-volume mode in which only the main bag portion 28, 28A are inflated and during inflation in the large-volume mode in which both the main bag portion 28, 28A and the subsidiary bag portion 45, 45A are inflated. Of course, the gas exhaust portion is not essential, and an airbag having no gas exhaust portion may be used.

What is claimed is:

1. A passenger seat airbag device, comprising:
an airbag that is disposed in front of an occupant seated in a passenger seat and is folded and stored in a storage portion;
an inflator that supplies an inflation gas to the airbag; and
a control mechanism that controls an inflation shape of the airbag, wherein
the airbag is formed in a bag shape having flexibility, and includes:
a main bag portion provided with an inflow opening for allowing the inflation gas to flow into an inside of the airbag, and configured to have an occupant-side wall portion disposed to face the occupant on a rear end side at a time of full inflation, in which a peripheral edge of the inflow opening on a front end side at the time of full inflation is coupled to a side of the storage portion; and
a subsidiary bag portion configured to communicate with the main bag portion and to be inflated to protrude rearward from a side of the occupant-side wall portion, in which inflation of the subsidiary bag portion is controlled by the control mechanism,
the airbag further includes a coupling member disposed in the main bag portion, the coupling member having a base end portion which is coupled to an inner peripheral surface of the subsidiary bag portion and a distal end portion which is coupled to the control mechanism disposed in a vicinity of the inflow opening, and
the subsidiary bag portion communicates with the main bag portion via a communication portion, and is configured,
when the main bag portion is inflated in a state where coupling between the coupling member and the control mechanism is maintained, to be in a state of being drawn into the main bag portion through the communication portion, and
when the main bag portion is inflated in a state where the coupling between the coupling member and the control mechanism is released, to be inflated to protrude rearward from the occupant-side wall portion such that the occupant is protected by a rear surface of the subsidiary bag portion at a time of full inflation.

2. The passenger seat airbag device according to claim 1, wherein
the airbag is formed in a bag shape by joining peripheral edges of base materials having a predetermined shape formed of a sheet body having flexibility to each other,
the subsidiary bag portion includes a front-side wall portion and a rear-side wall portion having a substantially same outer shape, the front-side wall portion being disposed on a front surface side facing the occupant-side wall portion at the time of full inflation, and the rear-side wall portion being disposed on a rear surface side to face the front-side wall portion,
the occupant-side wall portion includes two occupant-side panel portions dividing the occupant-side wall portion into two in an up-down direction or a left-right direction,
each of the occupant-side panel portions is configured such that a front wall forming portion constituting a half region of the front-side wall portion in the subsidiary bag portion is disposed to protrude on an inner edge side in which inner edges constitute a central region of the occupant-side wall portion and are joined to each other,
a rear panel portion constituting the rear-side wall portion in the subsidiary bag portion has an outer shape which is substantially equal to a shape of a state where each front wall forming portion of each of the occupant-side panel portions is opened in a state where the inner edges are joined to each other, and
the coupling member is formed to extend from two positions facing each other in a direction along a dividing direction of the occupant-side wall portion on an outer peripheral edge of the subsidiary bag portion.

3. The passenger seat airbag device according to claim 2, wherein
the occupant-side panel portion is configured to divide the occupant-side wall portion into two in the left-right direction.

4. The passenger seat airbag device according to claim 2, wherein
the airbag is stored in the storage portion in a state of a folded-up body in which a preliminary folded bag formed by deploying the occupant-side wall portion in the main bag portion substantially flat and disposing the occupant-side wall portion on the inflow opening is folded to be reduced in front-rear and left-right directions, and
in the preliminary folded bag, the subsidiary bag portion is disposed on the occupant-side wall portion of the main bag portion in a state of being deployed flat such that the front-side wall portion and the rear-side wall portion overlap each other.
